(19) United States
(12) Patent Application Publication
(10) Pub. No.: US 2004/0161245 A1
(43) Pub. Date: Aug. 19, 2004

(54) Synchronous amplitude modulation for improved performance of optical transmission systems

(76) Inventor: Neal S. Bergano, Lincroft, NJ (US)

Correspondence Address: Donald J. Perreault, Grossman, Tucker, Perreault & Pfleger, PLLC, 55 South Commercial Street, Manchester, NH, 03101, US

(21) Appl. No.: 10/780,830

(22) Filed: Feb. 18, 2004

Related U.S. Application Data
(63) Continuation-in-part of application No. 10/689,484, filed on Oct. 20, 2003.
Application No. 10/689,484 is a continuation of application No. 10/315,560, filed on Dec. 10, 2002, now Pat. No. 6,744,992.
Application No. 10/315,560 is a continuation of application No. 09/776,942, filed on Jan. 17, 2001, now Pat. No. 6,556,326.
Application No. 09/776,942 is a continuation of application No. 08/771,097, filed on Dec. 20, 1996, now abandoned.

(51) Int. Cl. H04B 10/04

(52) U.S. Cl. 398/186

(57) ABSTRACT

A method and apparatus for placing synchronous amplitude modulation onto an optical data signal. An amplitude modulator imparts periodic intensity modulation to an optical signal on which data has been, or will be, modulated. A phase modulator may also be provided to impart synchronous phase modulation to the optical signal, and a polarization modulator may be provided to impart polarization modulation.

### CROSS-REFERENCE TO RELATED APPLICATIONS

The present application is a continuation-in-part of U.S. application Ser. No. 10/689,484, filed Oct. 20, 2003, which is a continuation of U.S. application Ser. No. 10/315,560, filed Dec. 10, 2002, which is a continuation of U.S. application Ser. No. 09/776,942, filed Jan. 17, 2001, now U.S. Pat. No. 6,556,326, which is a continuation of U.S. application Ser. No. 08/771,097, filed Dec. 20, 1996, now abandoned, the teachings of which applications are incorporated herein by reference.

### TECHNICAL FIELD

The present application relates to the optical transmission of information and more particularly, to a method and apparatus for improving transmission capabilities over optical fiber transmission systems.

### BACKGROUND

Very long optical fiber transmission paths, such as those employed in undersea or transcontinental terrestrial lightwave transmission systems, which employ optical amplifier repeaters, are subject to decreased performance due to a host of impairments that accumulate along the length of the optical fiber in the transmission path. The source of these impairments within a single data channel includes amplified spontaneous emission (ASE) noise generated in the Erbium-Doped Fiber-Amplifiers (EDFAs), nonlinear effects caused by dependence of the single-mode fiber's index on the intensity of the light propagating through it, and chromatic dispersion which causes different optical frequencies to travel at different group velocities. In addition, for wavelength division multiplexed (WDM) systems, where several optical channels might be on the same fiber, crosstalk between channels caused by the fiber's nonlinear index should be considered.

It has been advantageous to operate long-haul transmission systems at high data rates per channel. For example, multiples of the Synchronous Digital Hierarchy (SDH) standard of 2.5 Gb/s are generally considered useful. Generally speaking, the impairments that limit the system's performance cause two types of degradations in the received eye pattern, which are related to randomness (caused by noise) and deterministic degradations (or distortions in the received bit pattern). Distortions of the second type are sometimes referred to as Inter-Symbol Interference (ISI). As the bit rates rise into the gigabit per second range it is useful to manage those impairments that affect the shape of the received pulses, and to limit the ISI.

Distortions of the received waveform are influenced by the shape of the transmitted pulses and the details of the design of the transmission line. Two signaling formats considered useful in long-haul transmission systems are the non-return-to-zero (NRZ) and solitons formats. The transmission format used in most long-haul lightwave systems has been the NRZ format because it is easy to generate, detect and process. The name NRZ is applied to this format because it describes the waveform's constant value characteristic when consecutive binary ones are sent. Alternatively, strings of binary data with optical pulses that do not occupy the entire bit period are described generically as Return-to-Zero or RZ. Two examples of RZ signaling pulses are a rectangular pulse that occupies one half of the bit period, and a hyperbolic secant pulse (or soliton) with a pulse width of about ⅕ of the time slot.

Known methods of reducing noise and distortion in lightwave transmission systems include the application of synchronous polarization and phase modulation to the NRZ signaling format (see U.S. Pat. No. 5,526,162), dispersion management of the transmission line, or the use of optical solitons. Scrambling the state-of-polarization of the optical carrier at the bit-rate of the transmitted NRZ signal can greatly improve the transmission performance of long-haul optical amplified transmission systems. In addition to synchronous polarization scrambling, superimposed phase modulation (PM) can dramatically increase the eye opening of the received data pattern. This increase results from the conversion of PM into bit-synchronous amplitude modulation (AM) through chromatic dispersion and nonlinear effects in the fiber. These synchronous polarization/phase modulation techniques were used in a WDM transmission system having a total transmission capacity of 100 Gb/s (20 WDM channels at 5 Gb/s) over 6300 km, as discussed in Bergano, et al., “100 Gb/s WDM Transmission of Twenty 5 Gb/s NRZ Data Channels Over Transoceanic Distances Using a Gain Flattened Amplifier Chain,” European Conference on Optical Communication (ECOC'95), Paper Th.A.3.1, Brussels, Belgium, Sep. 17-21, 1995.

While these methods have been effective, it is desirable to further improve the performance of long distance optical transmission systems.

### BRIEF DESCRIPTION OF THE DRAWINGS

FIG. 1 shows a simplified block diagram of one exemplary embodiment of a synchronous amplitude modulated transmitter consistent with the present invention.

FIG. 2 shows exemplary waveforms and corresponding eye diagrams output from an exemplary transmitter consistent with the invention showing different levels of synchronous amplitude modulation.

FIG. 3 shows exemplary eye diagrams output from an exemplary transmitter consistent with the invention, each, of the eye diagrams being associated with different amounts of delay between the data modulation, and the synchronous amplitude modulation.

FIG. 4 shows a simplified block diagram of another exemplary embodiment of a transmitter consistent with the invention including synchronous optical phase modulation, amplitude modulation, and polarization modulation.

FIG. 5 shows a resulting Q-factor verses the level of synchronous amplitude modulation for an arrangement employing a similar transmitter to that shown in FIG. 4.

FIG. 6 shows an embodiment of a transmission system architecture consistent with the invention including a synchronously modulated transmitter, receiver, transmission path, and telemetry path.

FIG. 7A shows a prior art Mach-Zehnder modulator configured for operation as an optical signal phase modulator.

FIG. 7B is a plot of optical signal power vs. time for a prior art differential phase shift keying modulation format.

FIG. 8 shows exemplary waveforms and corresponding eye diagrams output from an exemplary transmitter consistent with the invention using a DPSK modulation format and different levels of synchronous amplitude modulation.

FIG. 9 is a plot of Q-factor verses the path averaged launch power for a RZ-DPSK formatted signal transmitted using a transmitter consistent with the invention.

FIG. 10 shows a simplified block diagram of another exemplary embodiment of a transmitter -consistent with the invention including synchronous optical phase modulation and amplitude modulation.

FIG. 11 is a plot of Q-factor verses the path averaged launch power for a CRZ-DPSK formatted signal transmitted using a transmitter consistent with the invention including synchronous optical phase modulation and amplitude modulation.

### DETAILED DESCRIPTION

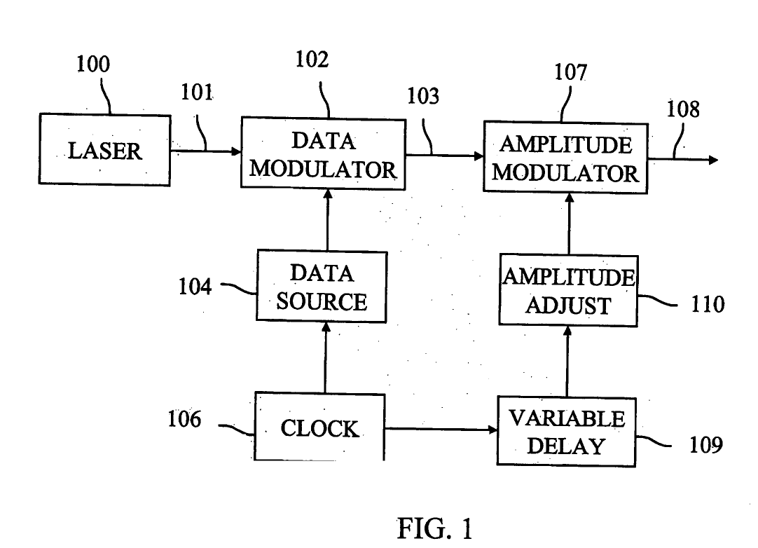

FIG. 1 shows a simplified block diagram of an exemplary optical transmitter consistent the invention. As shown, the transmitter includes a laser 100 for producing a continuous wave (CW) optical signal 101. The optical signal 101 may be transmitted to a data modulator 102 that modulates the signal to impart information thereto in a well-known fashion, producing a modulated optical information signal 103. The data modulator 102 may receive the data to be imparted to the optical signal 101 from a data source 104 and modulate the optical signal 101 at a frequency determined by a clock 106. The optical information signal 103 may be transmitted from the data modulator 102 to an amplitude modulator 107 which places intensity modulation on the optical information signal 103. Modulators 102 and 107 could be, for example, a 10 Gb/s modulator manufactured by Lucent Technologies as model number 2023.

Consistent with the present invention, the amplitude modulator 107 may be driven by the clock 106 so that the intensity of the optical information signal 103 is re-modulated at a rate equal to the rate at which data is imparted to the optical signal 101, which is defined by clock 106. As further shown in FIG. 1, it may be advantageous to provide an electrical variable-delay 109 and an amplitude adjustment mechanism 110 which couple the clock 106 to the amplitude modulator 107. The variable delay 109 may be employed to selectively adjust the phase of the amplitude modulation imparted by amplitude modulator 107 relative to the phase of the data modulation imparted by data modulator 102. The amplitude adjustment mechanism 110 may be employed to adjust the modulation depth that amplitude modulator 107 imparts to optical information signal 103. The optimal settings for these adjustments will depend on many parameters and can be determined empirically. Moreover, in a WDM system, the optimal setting for each channel may not necessarily be the same and thus the channels may be individually optimized.

The manner in which the clock 106 drives the amplitude modulator 107 may be described by examining the electric field components of the optical signal 103 on which the amplitude modulator acts. In x-y coordinates these components may be expressed as follows:

Eₓ(t)=Aₓ(t)e^{i(ωt+φ}^{ₓ}^{(t))} (1)

E_{y}(t)=A_{y}(t)e^{i(ωt+φ}^{_{y}}^{(t))} (2)

where ω is the optical carrier frequency, Aₓ(t) and A_{y}(t) are assumed to be real field amplitudes which include the intensity modulation imposed by data modulator 102, and φₓ(t) and φ_{y}(t) are the optical phase components and include any optical phase modulation that might be present. The amplitude modulator 107 may serve to modulate the optical signal by varying only the real amplitudes Aₓ(t) and A_{y}(t), with a function F(t) that is periodic and has a fundamental frequency component that is equal to, and phase locked to the clock signal generated by clock 106.

Amplitude modulator 107 may impress an amplitude modulation such that the intensity of signal 103 is multiplied by I(t). For purposes of illustration it is assumed that the periodic function F(t) is normalized to be in the range bounded by [+1, −1]. I(t) is given by:

I(t)=0.5*[(1−B)F(t+Ψₐₘ)+1+B] (3)

$$\begin{matrix}B ≡ \frac{100 - {A}_{am}}{100 + {A}_{am}} & & 0 \leq {A}_{am} \leq 100\end{matrix} \qquad ( 4 )$$

where Aₐₘ is the percentage of amplitude modulation placed on optical information signal 103 by modulator 107, and Ψₐₘ is the phase angle of the modulation with respect to the data modulation. Thus, I(t) is simply a scaled version of periodic function F(t) with a maximum value of unity, a minimum value of B, and is offset in time by Ψₐₘ. The level of the amplitude modulation may be adjusted by amplitude adjustment mechanism 110, and the offset Ψₐₘ may be adjusted by variable delay 109. The signal 108 from the transmitter may then be represented by the following electric field components:

Eₓ₋ₒᵤₜ(t)=\sqrt{I(t)}Aₓ(t)e^{i(ωt+φ}^{ₓ}^{(t))} (5)

E_{y-out}(t)=\sqrt{I(t)}A_{y}(t)e^{i(ωt+φ}^{_{y}}^{(t))} (6)

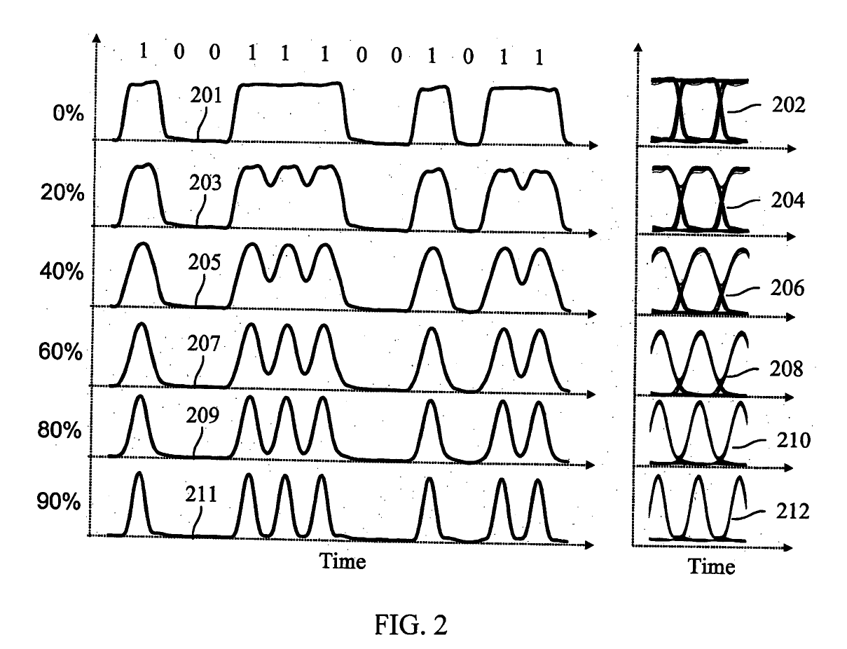

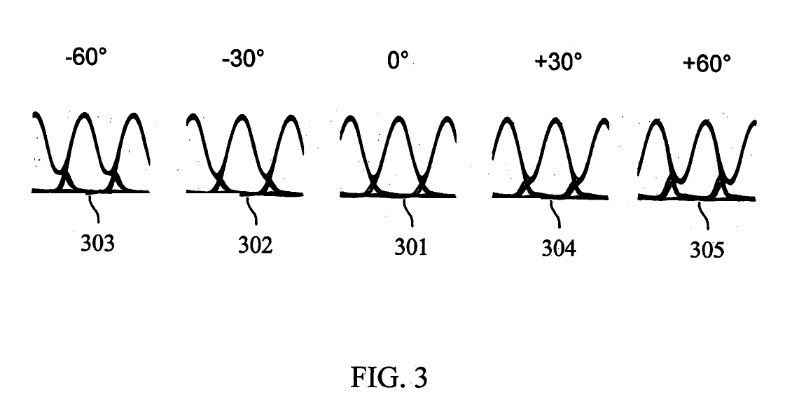

Equations (5) and (6) have been written in general terms for any periodic function that fits the above description. However, it may be advantageous to employ sinusoidal modulation, which will be the basis for the illustrative waveforms shown in FIG. 2 and FIG. 3.

FIG. 2 shows a series of waveforms representing an exemplary output signal 108 when the periodic waveform providing the amplitude modulation via modulator 107 is a sinusoidal function. Each waveform, which includes twelve bits, results from a different level of modulation depth imparted by the amplitude modulator 107. Adjacent to each waveform is its corresponding eye diagram. Waveform 201 and its corresponding eye diagram 202 are examples of a conventional NRZ waveform. Waveforms 203, 205, 207, 209, and 211, which respectively correspond to eye diagrams 204, 206, 208, 210, and 212, show waveforms for amplitude modulation levels of 20%, 40%, 60%, 80%, and 90%, respectively.

The waveforms generated by a system consistent with the present invention may not conveniently fit the definition of any conventional modulation format. For example, the waveforms shown in FIG. 2 are not constant in value over contiguous “1” bits and thus do not fit the standard definition of the NRZ format. In addition, since the waveforms do not necessarily return to zero between adjacent bits, they do not fit the standard definition of the RZ format. The waveform generated by a system consistent with the invention may thus provide a tradeoff between two regimes in the transmission system. In the illustrated exemplary waveforms, for example, the energy in the pulses is more concentrated near the center of the bit slot, which is desirable for limiting the amount of ISI, but since the bit almost fills the bit slot, the peak intensity may not be as large as it would be, for example, in a soliton system. In addition, the rise and fall times of the pulses may be reduced, which may lower the amount of chirp induced on the pulse by the fiber's nonlinear index.

One of ordinary skill in the art will recognize that the waveforms shown in FIG. 2 may be produced by variants of the transmitter shown in FIG. 1. For example, the modulation imparted in FIG. 1 by the amplitude modulator could be alternatively generated by electrical means prior to impressing the optical carrier signal 101 with data. For example, the data source 104 could supply to the modulator 102 electrical waveforms similar to those in shown in FIG. 2 so that the amplitude modulation is directly imparted onto the carrier signal 101. Alternatively, such an electrical waveform could be used to directly modulate a semiconductor laser, such as a distributed feedback laser. Also it is appreciated that the periodic waveform used to drive the additional modulation stage 107 in FIG. 1 need not be a sinusoid.

FIG. 3 illustrates the effects of the delay element 109 on the eye diagram by showing five eye diagrams of an exemplary output signal 108 for different phase offsets. The eye diagrams in this figure were all produced using a sinusoidal amplitude modulation level of 60%, similar to eye diagram 208 in FIG. 2. In eye diagram 301 the phase of the amplitude modulation is aligned with the phase-of the impressed data. Eye diagrams 302 and 303 were produced by shifting the phase of the amplitude modulation by −30° and −60°, respectively, with respect to the impressed data. Similarly, eye diagrams 304 and 305 were produced by shifting the phase of the amplitude modulation by +30° and +60°, respectively, with respect to the impressed data. A known amount of skew may be conveniently built into the transmitted eye by shifting the modulation phase in this manner. This feature may be used to correct for certain impairments found in high-speed lightwave communications. For example in systems using 10 Gb/s carriers, it is known that the single-mode fiber's third order dispersion can cause a skew in the received eye. By placing a known amount of skew in the transmitted eye it may be possible to offset some of the penalty associated with the impairment caused by the known waveform distortions.

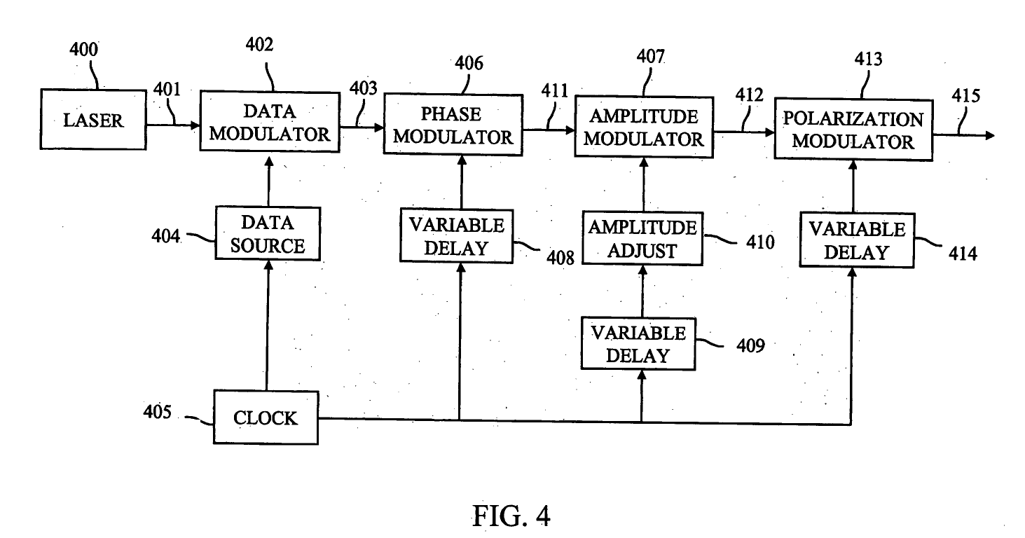

FIG. 4 shows an exemplary alternative embodiment of a system consistent with the invention in which the amplitude modulator 107 is used in connection with a transmitter employing synchronous polarization and optical phase modulation. An example of such a transmitter is disclosed in U.S. Pat. No. 5,526,162 to Bergano, the teachings of which are incorporated herein by reference. In FIG. 4, a laser 400 may produce a continuous wave (CW) optical signal 401. The optical signal 401 may be transmitted to a data modulator 402 that modulates the signal to impart information thereto in a well-known fashion, producing a modulated optical information signal 403. The data modulator 402 may receive the data to be imparted to the optical signal 401 from a data source 404 and modulate the optical signal 401 at a frequency determined by a clock 405. The optical information signal 403 may be transmitted from the data modulator 402 to optical phase modulator 406, amplitude modulator 407, and to polarization modulator 413. The clock 405 may drive the three modulation stages via a series of variable delay elements 408, 409, and 414, which may be used to selectively adjust the delay of the modulation imparted by modulators 406, 407, and 413 relative to the phase of the data modulation imparted by modulator 402. Consistent with the present invention, the amplitude modulator 407 may be driven by the clock 405 so that the intensity of the optical information signal is re-modulated at a rate equal to the rate at which data is imparted to the optical signal 401. Similar to the FIG. 1 embodiment, an amplitude adjustment mechanism 410 may be employed to set the modulation depth that amplitude modulator 410 imparts on signal 413.

The manner in which the clock 405 drives the phase modulator 406, amplitude modulator 407, and polarization modulator 413 may be described by examining the electric field components of the optical signal 415. These components are similar to those presented in equations (5) and (6) with the inclusion of additional phase terms. For example, assume that the synchronous modulation imparted by the modulators is sinusoidal. The transmitter shown in FIG. 4 may modify the optical phase of the signal produced by the transmitter of FIG. 1 while the amplitude is unchanged. In this case the phase modulation imparted to the optical signal includes two separate and independent phases: a phase Ψ₂ associated with polarization modulator 413 and a phase Ψ₁ associated with the optical phase modulator 406. Thus, the phase angles φₓ and φ_{y} of the optical signal 415 launched from the polarization modulator become:

φₓ(t)=aₓ cos(Ωt+Ψ₂)+b cos(Ωt+Ψ₁) (7)

φ_{y}(t)=a_{y} cos(Ωt+Ψ₂)+b cos(Ωt+Ψ₁) (8)

where aₓ and a_{y} are the phase modulation indices of the polarization modulator, b is the phase modulation index of the optical phase modulator, Ψ_{1,2} are the phase offsets set by delay elements 408 and 414, respectively, and Ω is the bit rate set by clock 405.

As equations (7) and (8) indicate, the optical phase modulator 406 may impart the same phase modulation to both the x and y components of the optical signal. Accordingly, the optical phase modulator 406 may modulate the optical phase of signal 403 without modulating its polarization. The reason the optical phase modulator 406 does not modulate the polarization is because the polarization modulation of the optical signal is proportional to the difference between the phases φₓ and φ_{y} and this difference is unaffected by the optical phase modulator 406 since it modulates both φₓ and φ_{y} by equal amounts. In principle, every possible State-of-Polarization (SOP) of a monochromatic signal having these electric field components can be obtained by varying the ratio aₓ/a_{y} while maintaining the value of (aₓ²+a_{y}²) constant and varying the relative phase difference φₓ−φ_{y} between 0 and 2π. However, the polarization modulator 413 serves to modulate the SOP of the optical signal by varying only the difference of the phases φₓ and φ_{y}, which is sufficient to provide a SOP whose average value over a modulation cycle is low. Polarization modulator 413 may alter the SOP of the optical information signal in such a way that the degree of polarization over the modulation period is reduced from unity. Accordingly, the output signal 415 may have a degree of polarization that can be substantially equal to zero and is said to be polarization scrambled. The polarization modulator 413 may serve to trace the SOP of optical information signal 415 on a complete great circle of the Poincare sphere. Alternatively, the SOP of the optical signal may reciprocate along the Poincare sphere. In either case, the average value of the SOP over each modulation cycle may be substantially lowered from its normal value of unity.

One of ordinary skill in the art will recognize that the functions of the various modulators are shown in FIG. 4 for purposes of illustration only and that two or more of the modulators may be realized in a single functional unit. For example, as previously mentioned, data modulator 402 may also function as the amplitude modulator 407 by having the data source 404 provide the proper electrical drive signal. In addition, the functions of phase modulator 406 and polarization modulator 413 may be combined in a manner similar to that shown in FIG. 3 of U.S. Pat. No. 5,526,162.

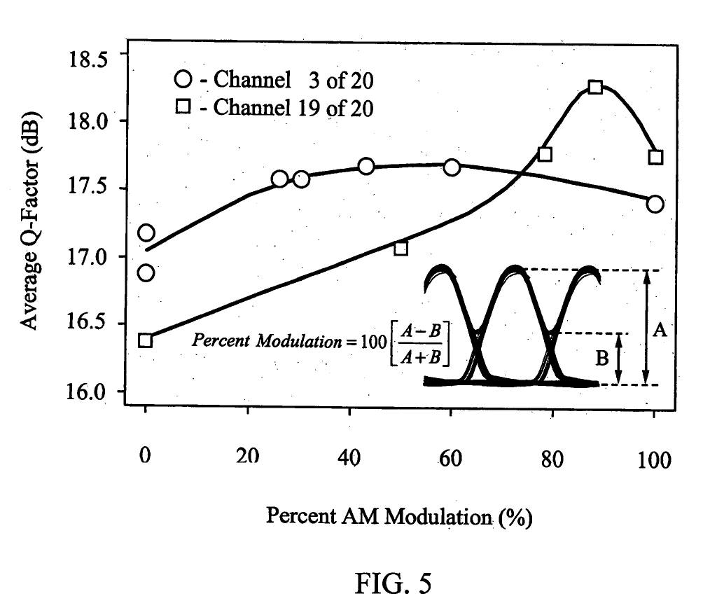

The experimental results presented in FIG. 5 were obtained from a transmitter of the type shown in FIG. 4, which incorporated an NRZ transmitter having synchronous amplitude, phase, and polarization modulation. The transmission path, which used circulating loop techniques, extended 9,300 kms and employed twenty WDM channels, each operating at a bit rate of 5.0 Gbits/sec with an average launch power of +7 dBm for all of the channels. The experiment was similar to the results for a twenty channel system presented by Bergano and Davidson in IEEE Journal of Lightwave Technology, Vol. 14, No. 6, p. 1299 June 1996, except that in the present arrangement the EDFAs were pumped at 980 nm, which improved the noise figure and increased the transmission distance. FIG. 5 shows the resulting Q-factor (i.e., the electrical. signal-to-noise ratio) versus the depth of modulation for channels 3 and 19. The two channels are representative of two different chromatic dispersion regimes of the system. Channel 3, located at 6.8 nm below the zero dispersion wavelength λ₀ had an average dispersion of −0.51 ps/km-nm and channel 19 located 2.8 nm higher that λ₀ had an average dispersion of +0.21 ps/km-nm. The data indicates that good Q-factor performance can be achieved by selecting an appropriate value for the depth of modulation. The appropriate value may differ from both the pure NRZ format (0% depth of modulation) and the RZ format (greater than 100% depth of modulation). FIG. 5 also provides a definition used to calculate the depth of modulation.

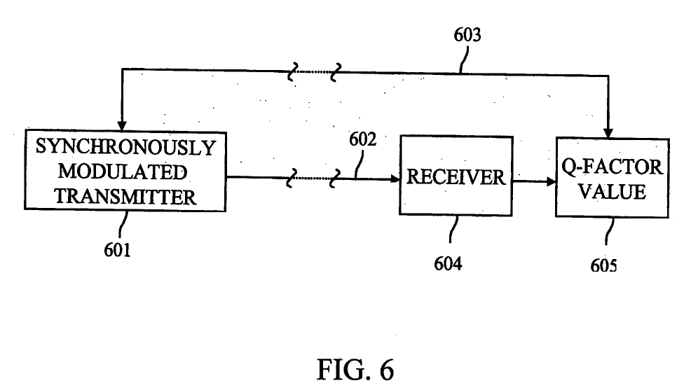

FIG. 6 is an example of a transmission system including a transmitter, receiver, transmission path, and telemetry path consistent with the present invention. Shown are a synchronously modulated transmitter 601 such as shown in FIGS. 1 or 4, transmission medium 602, and telemetry path 603 which connects equipment at the receiver side to the transmitter side to feedback a characteristic of the received signal such as the Q-factor. Transmission medium 602, for purposes of this example, but not as a limitation on the invention, is a chain of optical amplifiers and single-mode optical fibers. These elements are well known in the art. Transmitter 601 may produce an optical information signal whose amplitude, and/or optical phase and polarization is synchronously modulated as described above. At the receiver, the Q-factor may be measured as an indication of transmission performance with a Q-factor measurement apparatus 605. The Q-factor, which provides a method for determining the transmission performance of signals after propagation through lightwave systems, is discussed in Bergano et al., IEEE Phot. Tech. Lett., Vol. 5, No. 3, March 1993. Apparatus 605 may be, for example, a Q measurement unit manufactured by Advantest under the model number D3281. The Q-factor may be sent back to the transmitter 601 via telemetry path 603. It will be appreciated by those skilled in the art that it may be desirable, in some applications, for telemetry path 603 to be part of the same transmission system, such as overhead bits in a SDH frame, or an order-wire channel, or be transmitted on a different channel, such as a separate phone line. The Q-factor may be received and processed by a logic element that may be located, for example, within the synchronously modulated transmitter 601. The logic element may control the level and the relative timing of the various modulation stages imparted to the signal from transmitter 601 to maximize the received Q-factor. This type of feedback system may be provided to assist in maintaining adequate transmission performance in the presence of a fading channel, which can be caused by polarization effects.

As indicated above, the data modulator 102 may modulate the optical signal to impart information thereto in a well-known fashion. A variety of data modulator configurations for applying a variety of modulation formats are well-known to those of ordinary skill in the art. For example, the data modulator 102 may be configured modulate the optical signal using a well-known format such as NRZ, RZ, phase shift keying (PSK), differential phase shift keying (DPSK), etc.

In an embodiment wherein the data modulator 102 is configured to modulate the optical signal to impart information thereto using a DPSK format, the data modulator 102 may receive the data to be imparted to the optical signal 101 from a data source 104 and modulate the optical signal 101 at a frequency determined by a clock 106 to form a DPSK modulated signal 103 in a well-known manner. The DPSK modulated optical information signal 103 may be transmitted from the data modulator 102 to an amplitude modulator 107 which places a synchronous intensity modulation on the optical information signal 103.

The intensity modulation imparted by the amplitude modulator 107 may be periodic. To impart periodic amplitude modulation, the modulator 107 may be driven by a periodic signal, such as a sinusoidal signal. In one embodiment, the amplitude modulator 107 may be configured to impart amplitude modulation without also applying phase modulation to the signal. The amplitude modulator 107 may thus re-modulate the DPSK modulated signal 103 at a rate equal to the rate at which data is imparted to the optical signal 101 defined by clock source 106. In such an embodiment, modulators 102 and 107 may, for example, be type 2612 and/or 2622 SLIM-PAC modulators manufactured and sold by AT&T Microelectronics.

The DPSK data modulator 102 in such an embodiment may include a Mach-Zehnder-type optical modulator as described, for example, in T. Chikama, et al., “Modulation and Demodulation Techniques in Optical Heterodyne PSK Transmission Systems,” Journal of Lightwave Technology, Vol. 8, No. 3, March 1990 pages 309-322, the teachings of which are hereby incorporated by reference. In such a configuration the optical phase of the signal 103 emerging from the data modulator changes abruptly from 0° to 180° (or 0 to π radians) on the transitions between differential bits, thus providing a high-fidelity digital phase modulation.

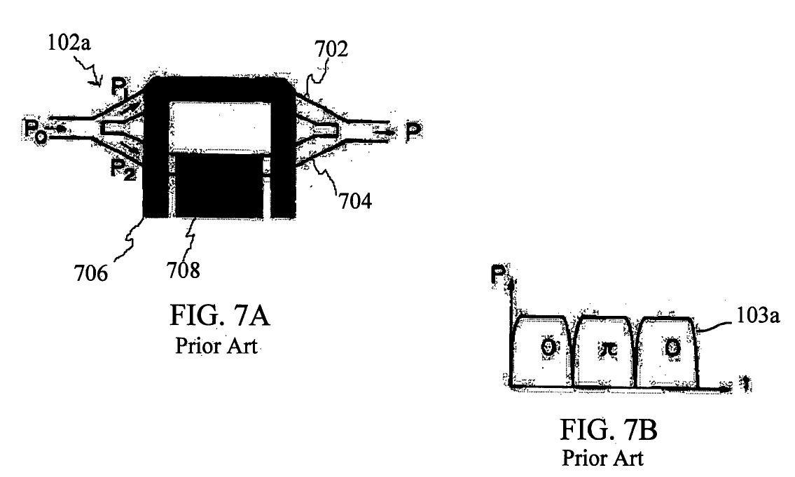

FIG. 7A, for example, illustrates the structure and operation of an exemplary Mach-Zehnder-type optical phase modulator 102a, as described in the above-mentioned publication by T. Chikama et al. As shown, an input optical signal, e.g. signal 101, having a total power P₀ is branched into equal segments P₁, P₂ on the two waveguide structures 702, 704 of the Mach-Zehnder modulator 102a. DPSK modulation may be achieved by applying a voltage between the two electrodes 706, 708 to cause the optical phase in waveguide 702 to rotate counterclockwise and the optical phase in waveguide 704 to rotate clockwise. As discussed in the publication by T. Chikama et al, if the modulation efficiencies of the waveguides 702, 704 are equal, the phase of the combined optical signal P (e.g. signal 103) changes, abruptly from 0° to 180°, depending on the rotation angle of the phase at each waveguide. FIG. 7B, for example, is a plot of output power vs. time for an exemplary output 103a of modulator 102a for a 0, π, 0 phase modulation sequence. DPSK modulation may thus be generated by selecting the appropriate driving voltage bias point for data modulator 102a. Those of ordinary skill in the art will recognize that the driving voltage and bias point may be established by a data source 104 including a differential encoder of the type typically employed in a DPSK system. Alternatively, a differential encoder could be used at the receiving terminal of a transmission system.

Again, in an embodiment where the data modulator 102 is a DPSK modulator, it may be advantageous to provide an electrical variable-delay 109 and an amplitude adjustment 110. The variable delay 109 may be used to selectively adjust the phase of the amplitude modulation imparted by data modulator 107 relative to the phase of the data modulation imparted by data modulator 102 or 102a. The amplitude adjustment 110 may be used to set the depth of modulation that amplitude modulator 107 imparts on signal 103. The optimal settings for these adjustments will depend on many parameters in the system, and can be determined empirically. In one embodiment, the delay provided by variable delay 109 may be set to align the center of the data bits on line 103 with the peak amplitude point of the synchronous amplitude modulation provided by modulator 107. Again, in a WDM system, the optimal setting for each channel may not necessarily be the same and thus the channels may be individually optimized.

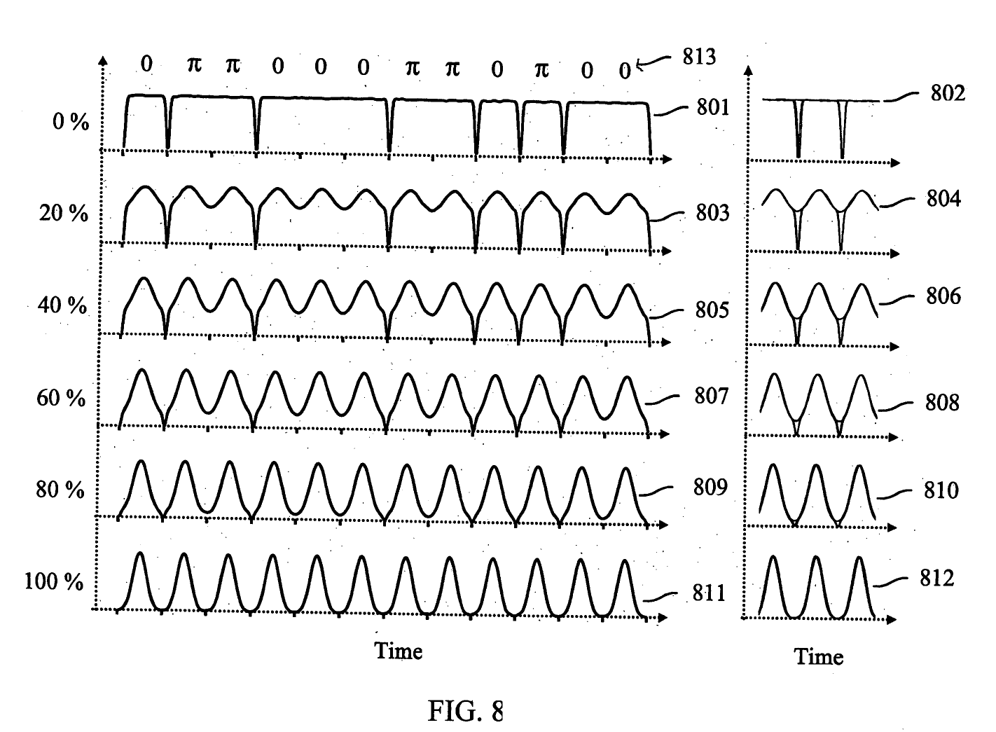

FIG. 8 shows a series of exemplary waveforms representing the output signal 108 when the data source 104 and modulator 102 are configured to impart DPSK modulation to the optical signal 101, and amplitude modulator 107 is configured to provide synchronous periodic amplitude modulation. Each of the illustrated waveforms results from a different level of depth of amplitude modulation imparted by the amplitude modulator 107. Adjacent to each waveform is its corresponding eye diagram. In each waveform twelve bits of data are modulated onto the phase difference between two adjacent time slots. The optical phase of the signal in each of the time slots is indicated by the phase modulation sequence 813 given by the 0's and π's. After DPSK demodulation in the receiver the waveforms may look similar to those shown in FIG. 2.

Waveform 801 and eye diagram 802 are examples of intensity profiles for a conventional DPSK waveform. Waveforms 801 and 802 are sometimes referred to as representing Non-Return-to-Zero DPSK (NRZ-DPSK). Waveforms 803, 805, 807, 809, and 811, which respectively correspond to eye diagrams 804, 806, 808, 810, and 812, show waveforms for 20%, 40%, 60%, 80%, and 100% amplitude modulation, respectively. These different levels of amplitude modulation may, for example, be established by the amplitude adjustment mechanism 110.

As shown, the optical intensity of waveforms 803, 805, 807, 809 and 811 is not constant during contiguous blocks of binary 0's or π's and thus does not fit the standard definition of NRZ-DPSK. The optical intensity of waveform 811 returns substantially to zero during contiguous blocks of binary 0's or π's and hence is sometimes referred to as representing Return-to-Zero DSPK (RZ-DPSK). The optical intensity of waveforms 803, 805, 807 and 809 is not constant but does not necessarily return to the zero level between bits. These waveforms 803, 805, 807 and 809 thus do not fit the standard RZ or NRZ definition, illustrating a format providing a tradeoff between the two regimes. As discussed above in connection with the waveforms illustrated in FIG. 2, the energy in the pulses is more concentrated near the center of the bit slot, but since the bit nearly fills the bit slot, the peak intensity is not as large as it would be for example in a soliton system. In addition, the rise and fall times are slowed down.

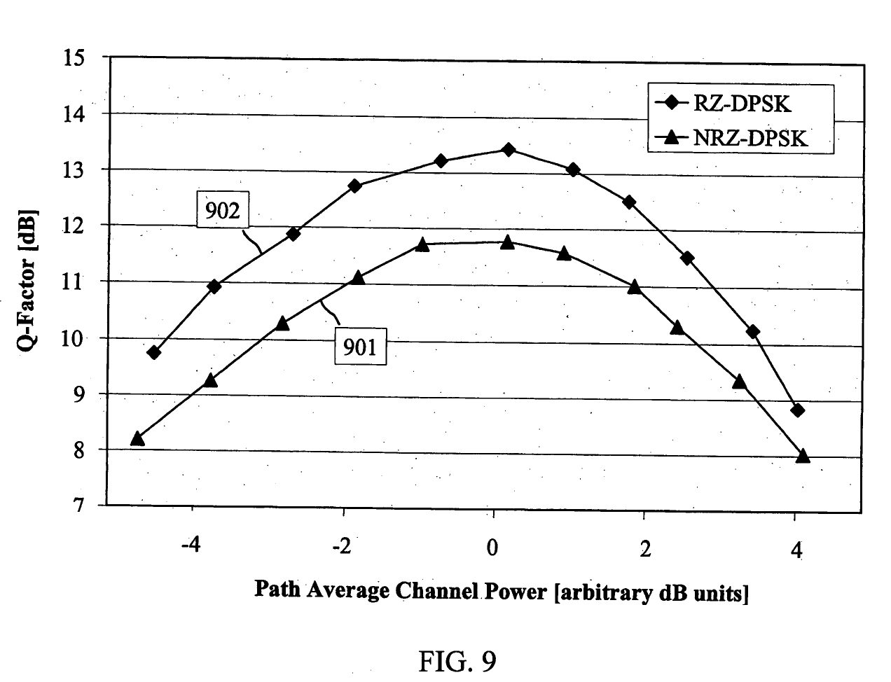

FIG. 9 includes plots 901 and 902 of Q-factor vs. path-averaged optical power for one channel of a WDM transmission experiment using a transmitter consistent with FIG. 1 and incorporating a DPSK data modulator with synchronous amplitude modulation. The transmission path used in the experiment extended about 13,000 km and included conventional non slope-matched dispersion shifted fibers with a system dispersion slope of ˜0.08 ps/nm²/km. A total of 96 channels were transmitted, each operating at a line bit rate of 12.3 GB/s, and a WDM spacing of 33 GHz. FIG. 9 shows Q-factor performance of channel 33 measured at several values of path-averaged optical power along the transmission line. Plot 901 shows the Q-factor performance of channel 33 with a DPSK data modulator and a 0% depth of modulation imparted by amplitude modulator 107 (i.e. a conventional NRZ-DPSK format). Plot 902 shows the Q-factor performance of channel 33 with a DPSK data modulator and synchronous amplitude modulation imparted by modulator 107 at ˜100% depth of modulation (corresponding to waveform 811 and eye diagram 812 in FIG. 8). As shown, use of a synchronously modulated DPSK format consistent with the present invention results in a Q-factor improvement of about 1.5 dB compared to use of a conventional NRZ-DPSK format.

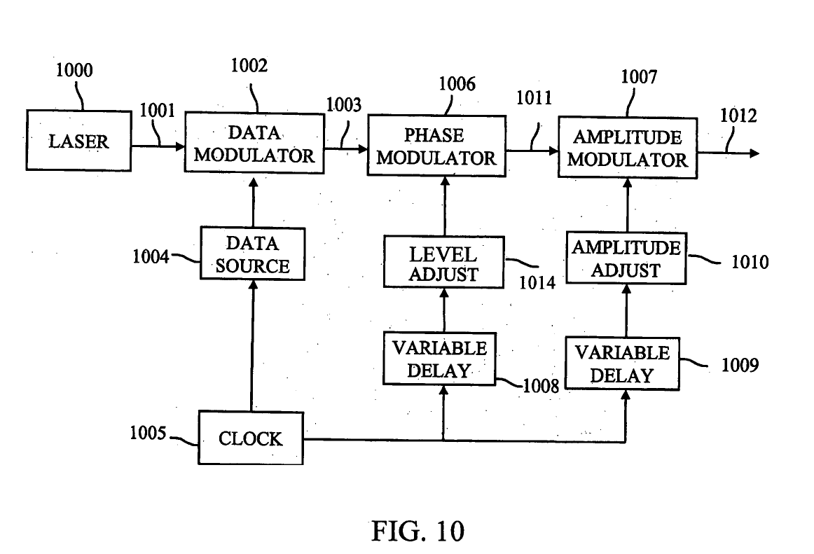

FIG. 10 illustrates another exemplary embodiment consistent with the invention wherein an amplitude modulator 1007 is provided along with a phase modulator 1006 configured to provide synchronous optical phase modulation. The illustrated exemplary embodiment includes a laser 1000 for producing a continuous wave (CW) optical signal 1001. The optical signal 1001 may be transmitted to a data modulator 1002 that modulates the signal to impart information thereto in a DPSK format, producing a DPSK modulated optical information signal 1003. The data modulator 1002 may receive the data to be imparted to the optical signal 1001 from a data source 1004 and modulate the optical signal 1001 at a frequency determined by a clock 1005. The optical DPSK information signal 1003 may be transmitted from the data modulator 1002 to optical phase modulator 1006, then amplitude modulator 1007. The clock 1005 may drive these modulation stages through variable delay elements 1008 and 1009. The variable delay elements may be employed to selectively adjust the delays of the synchronous phase and amplitude modulations imparted by phase modulator 1006 and amplitude modulator 1007, respectively, relative to the phase of the data modulation imparted by data modulator 1002. The amplitude modulator 1007 may be driven by the clock 1005 so that the intensity of the optical information signal is re-modulated at a rate equal to the rate at which data is imparted to the optical signal 1001. An amplitude adjustment mechanism 1010 may be used to set the depth of modulation imparted by the amplitude modulator 1007, and a level adjustment mechanism 1014 may be used to set the level of phase modulation imparted by the phase modulator 1006.

In operation, laser 1000, data modulator 1002 and data source 1004 may generate the DPSK modulated optical signal 1003 in a manner well-known in the art. The level of synchronous amplitude and phase modulation applied to the optical signal may be adjusted using adjustment mechanism 1010 to optimize system performance. For example, amplitude adjustment 1010 may be set to give 100% depth of modulation to generate an RZ-DPSK signal with synchronous phase modulation applied by phase modulator 1006, which has been referred to as a chirped return-to-zero differential phase shifted keyed (CRZ-DPSK) format. The amount of synchronous phase modulation applied by phase modulator 1006 may be adjusted using level adjustment mechanism 1014 to optimize system performance.

As will be recognized by those of ordinary skill in the art, the modulation stages 1002, 1006, and 1007 need not be separate electro-optic packaged devices. One or more of the stages may be combined into a single packaged device. Also the modulation stages are shown in a particular order for illustrative purposes only. The order in which modulation is applied to the optical signal 1001 may be varied without adversely affecting performance. For example, synchronous amplitude modulation may be applied directly to the laser output with the data modulation and/or phase modulation applied thereafter. Also, as discussed above, modulation may be generated by electrical waveforms, e.g. through direct modulation of the laser.

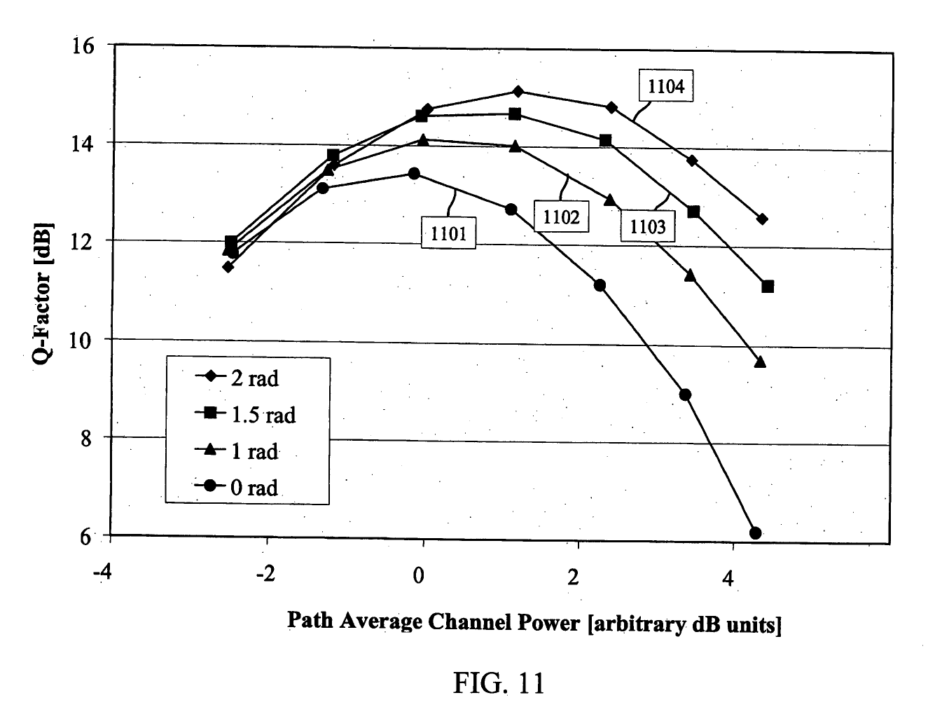

FIG. 11 includes plots 1101, 1102, 1003 and 1104 of Q-factor vs. path-averaged optical power for a WDM transmission experiment using a transmitter consistent with FIG. 10 incorporating a DPSK data modulator with synchronous amplitude and phase modulation. The transmission path used in this measurement was the same path as described for FIG. 9, and the results are shown for channel 30, which had accumulated dispersion of −4,700 ps/nm. Plot 1101 was recorded without any additional phase modulation; plots 1102, 1103, and 1104 were recorded for 1 radian, 1.5 radians, and 2.0 radians, respectively, of peak-to-peak synchronous phase modulation. Each of the data sets associated with plots 1101, 1102, 1103, and 1104 were recorded using the same amount of synchronous amplitude modulation at ˜100% depth of modulation. The x-axis in FIG. 11 corresponds to the path averaged powers of six 100-GHz spaced neighboring WDM channels that were increased or decreased simultaneously.

As shown, channel performance and the channel power improved as the phase modulation increased. There was more than 2-dB improvement for the case with 2-radian phase modulation (plot 1104) compared to no phase modulation (plot 1101), thus demonstrating the effectiveness of the CRZ-DPSK format. The optimum path averaged power level for the phase modulated cases (plots 1102, 1103, and 1104) occurred at a higher path averaged power than without synchronous phase modulation. Thus synchronously modulated DPSK can tolerate higher powers. This improved high-power tolerance may be useful in the initial deployment of a long-haul system where the first few channels that are populated may operate with high path averaged powers. This added performance may be advantageous where the end-to-end transmission distances are very long.

The embodiments that have been described herein but some of the several which utilize this invention and are set forth here by way of illustration but not of limitation. For example, synchronously modulated DPSK as described in connection with FIGS. 1 and/or 10 may also be implemented with polarization modulation as described in connection with FIG. 4. Many other embodiments, which will be readily apparent to those skilled in the art, may be made without departing materially from the spirit and scope of the invention.

What is claimed is:

1. An apparatus for transmitting an optical signal comprising:
an optical signal source configured to generate an optical signal;
a data modulator coupled to said optical signal source and configured to modulate data on said optical signal at a data modulation frequency; and
an amplitude modulator coupled to said optical signal source and configured to provide a periodic modulation of the intensity of said optical signal.

2. The apparatus of claim 1 wherein said data source is configured to modulate said data on said optical signal using a DPSK modulation format.

3. The apparatus of claim 1 wherein said amplitude modulator is configured to provide said periodic modulation of the intensity of said optical signal at an intensity modulation depth greater than or equal to 20%.

4. The apparatus of claim 3 wherein said data source is configured to modulate said data on said optical signal using a DPSK modulation format.

5. The apparatus of claim 1 wherein said amplitude modulator is configured to provide said periodic modulation of the intensity of said optical signal at an intensity modulation depth greater than or equal to 40%.

6. The apparatus of claim 1 wherein said amplitude modulator is configured to provide said periodic-modulation of the intensity of said optical signal at an intensity modulation depth greater than or equal to 60%.

7. The apparatus of claim 1 wherein said amplitude modulator is configured to provide said periodic modulation of the intensity of said optical signal at an intensity modulation depth greater than or equal to 80%.

8. The apparatus of claim 1 wherein said amplitude modulator is configured to provide said periodic modulation of the intensity of said optical signal at an intensity modulation depth equal to about 100%.

9. The apparatus of claim 1 wherein said amplitude modulator is coupled to said optical signal source through said data modulator.

10. The apparatus of claim 1 wherein said amplitude modulator is configured to impart said periodic modulation in response to a sinusoidal drive signal.

11. The apparatus of claim 1 wherein said periodic modulation is provided at an amplitude modulation frequency phase locked to said data modulation frequency.

12. The apparatus of claim 11 wherein said amplitude modulation frequency is equal to said data modulation frequency.

13. The apparatus of claim 1, wherein said data modulation frequency is established by a clock coupled to said amplitude modulator.

14. The apparatus of claim 1 wherein the optical signal source comprises a continuous-wave optical signal generator, wherein said data is provided to said data modulator by a data source coupled to said data modulator, and wherein said apparatus further comprises a clock for establishing said data modulation frequency.

15. The apparatus of claim 14, wherein said continuous-wave optical signal generator comprises a laser.

16. The apparatus of claim 1 wherein the amplitude modulator is configured to provide said periodic modulation of the intensity of said optical signal with a prescribed phase.

17. The apparatus of claim 16 further comprising an electrical variable-delay line for selectively varying the prescribed phase.

18. The apparatus of claim 17 wherein said electrical variable-delay line comprises a phase shifter.

19. The apparatus of claim 1, said apparatus further comprising means for selectively adjusting a depth of said periodic modulation of the intensity of said optical signal.

20. The apparatus of claim 1 further comprising a phase modulator configured to provide optical phase modulation to said optical signal.

21. The apparatus of claim 20 wherein said amplitude modulator is coupled to said data modulator through said phase modulator.

22. The apparatus of claim 20 wherein said phase modulator is configured to provide said optical phase modulation at a phase modulation frequency that is phase locked to said data modulation frequency.

23. The apparatus of claim 22 wherein said phase modulation frequency is equal to said data modulation frequency.

24. The apparatus of claim 22 further comprising a clock for establishing said data modulation frequency and said phase modulation frequency.

25. The apparatus of claim 20 said apparatus further comprising means for selectively adjusting a level of said optical phase modulation.

26. The apparatus of claim 20 further comprising an electrical variable-delay line for selectively varying the phase of said optical phase modulation provided by said phase modulator.

27. The apparatus of claim 26 wherein said electrical variable-delay line comprises a phase shifter.

28. The apparatus of claim 1 further comprising a polarization modulator coupled to said data modulator for modulating the state of polarization of said optical signal at said data modulation frequency.

29. The apparatus of claim 28 wherein said polarization modulator is configured for modulating the state of polarization of said optical signal such that an average value of the state of polarization over a modulation cycle is substantially equal to zero.

30. The apparatus of claim 28 wherein said polarization modulator is coupled to said data modulator through said amplitude modulator.

31. The apparatus of claim 28 wherein said polarization modulator modulates the state of polarization by tracing the polarization of said optical signal along at least a portion of a Poincare sphere.

32. The apparatus of claim 28 wherein the polarization modulator modulates the state of polarization of the optical signal at said data modulation frequency with a prescribed phase.

33. The apparatus of claim 32 further comprising an electrical variable-delay line coupled to said polarization modulator for selectively varying the prescribed phase.

34. The apparatus of claim 33 wherein said electrical variable-delay line comprises a phase shifter.

35. An apparatus for transmitting an optical signal comprising:
an optical signal source configured to generate an optical signal;
a data modulator coupled to said optical signal source and configured to modulate data on said optical signal at a data modulation frequency using a DPSK modulation format; and
an amplitude modulator coupled to said optical signal source and configured to provide a periodic modulation of the intensity of said optical signal at an amplitude modulation frequency phase locked to said data modulation frequency.

36. The apparatus of claim 35 wherein said amplitude modulator is configured to provide said periodic modulation of the intensity of said optical signal at an intensity modulation depth greater than or equal to 20%.

37. The apparatus of claim 35 wherein said amplitude modulator is configured to provide said periodic modulation of the intensity of said optical signal at an intensity modulation depth greater than or equal to 40%.

38. The apparatus of claim 35 wherein said amplitude modulator is configured to provide said periodic modulation of the intensity of said optical signal at an intensity modulation depth greater than or equal to 60%.

39. The apparatus of claim 35 wherein said amplitude modulator is configured to provide said periodic modulation of the intensity of said optical signal at an intensity modulation depth greater than or equal to 80%.

40. The apparatus of claim 35 wherein said amplitude modulator is configured to provide said periodic modulation of the intensity of said optical signal at an intensity modulation depth equal to about 100%.

41. The apparatus of claim 35 wherein said amplitude modulator is coupled to said optical signal source through said data modulator.

42. The apparatus of claim 35 wherein said amplitude modulator is configured to impart said periodic modulation in response to a sinusoidal drive signal.

43. The apparatus of claim 35 wherein the amplitude modulator is configured to provide said periodic modulation of the intensity of said optical signal with a prescribed phase.

44. The apparatus of claim 43 further comprising an electrical variable-delay line for selectively varying the prescribed phase.

45. The apparatus of claim 35, said apparatus further comprising means for selectively adjusting a depth of said periodic modulation of the intensity of said optical signal.

46. The apparatus of claim 35 further comprising a phase modulator configured to provide optical phase modulation to said optical signal.

47. The apparatus of claim 46 wherein said phase modulator is configured to provide said optical phase modulation at a phase modulation frequency that is phase locked to said data modulation frequency.

48. The apparatus of claim 47 wherein said phase modulation frequency is equal to said data modulation frequency.

49. The apparatus of claim 46 said apparatus further comprising means for selectively adjusting a level of said optical phase modulation.

50. The apparatus of claim 46 further comprising an electrical variable-delay line for selectively varying the phase of said optical phase modulation provided by said phase modulator.

51. The apparatus of claim 35 further comprising a polarization modulator coupled to said data modulator for modulating the state of polarization of said optical signal at said data modulation frequency.

52. The apparatus of claim 51 wherein said polarization modulator is configured for modulating the state of polarization of said optical signal such that an average value of the state of polarization over a modulation cycle is substantially equal to zero.

53. The apparatus of claim 51 wherein said polarization modulator modulates the state of polarization by tracing the polarization of said optical signal along at least a portion of a Poincare sphere.

54. The apparatus of claim 51 wherein the polarization modulator modulates the state of polarization of the optical signal at said data modulation frequency with a prescribed phase.

55. The apparatus of claim 54, further comprising an electrical variable-delay line coupled to said polarization modulator for selectively varying the prescribed phase.

56. A method of modulating an optical signal for transmission on an optical communication system, said method comprising:
modulating data on said optical signal at a data modulation frequency; and
imparting a periodic amplitude modulation on said optical signal.

57. The method of claim 56 wherein said data is modulated on said optical signal using a DPSK modulation format.

58. The method of claim 56 wherein said periodic amplitude modulation is imparted at modulation depth greater than or equal to 20%.

59. The method of claim 58 wherein said data is modulated on said optical signal using a DPSK modulation format.

60. The method of claim 56 wherein said periodic amplitude modulation is imparted at modulation depth greater than or equal to 40%.

61. The method of claim 56 wherein said periodic amplitude modulation is imparted at modulation depth greater than or equal to 60%.

62. The method of claim 56 wherein said periodic amplitude modulation is imparted at modulation depth greater than or equal to 80%.

63. The method of claim 56 wherein said periodic amplitude modulation is imparted at modulation depth equal to about 100%.

64. The method of claim 56 wherein said periodic modulation is imparted by driving an amplitude modulator with a sinusoidal drive signal.

65. The method of claim 56, wherein said periodic amplitude modulation is imparted at an amplitude modulation frequency phase locked to said data modulation frequency.

66. The method of claim 65 wherein said amplitude modulation frequency is equal to said data modulation frequency.

67. The method claim 56 further comprising selectively adjusting a depth of said periodic amplitude modulation.

68. The method of claim 56 wherein said modulating data on said optical signal is performed before said imparting said periodic amplitude modulation.

69. The method of claim 56 further comprising imparting phase modulation to said optical signal.

70. The method of claim 69 wherein said phase modulation is imparted at a phase modulation frequency phase locked to said data modulation frequency.

71. The method of claim 70 wherein said phase modulation is imparted at a phase modulation frequency equal to said data modulation frequency.

72. The method claim 69 further comprising selectively adjusting a level of said phase modulation.

73. The method of claim 56 further comprising imparting polarization modulation to said optical signal.

74. A transmission system comprising:
a transmitter including:
an optical signal source configured to generate an optical signal,
a data modulator coupled to said optical signal source and configured to modulate data on said optical signal at a data modulation frequency, and
an amplitude modulator coupled to said optical signal source and configured to provide a periodic modulation of the intensity of said optical signal;
an optical transmission path coupled to said transmitter; and
a receiver coupled to the optical transmission path.

75. The system of claim 74 wherein said data source is configured to modulate said data on said optical signal using a DPSK modulation format.

76. The system of claim 74 wherein said amplitude modulator is configured to provide said periodic modulation of the intensity of said optical signal at an intensity modulation depth greater than or equal to 20%.

77. The system of claim 76 wherein said data source is configured to modulate said data on said optical signal using a DPSK modulation format.

78. The system of claim 74 wherein said amplitude modulator is configured to provide said periodic modulation of the intensity of said optical signal at an intensity modulation depth greater than or equal to 40%.

79. The system of claim 74 wherein said amplitude modulator is configured to provide said periodic modulation of the intensity of said optical signal at an intensity modulation depth greater than or equal to 60%.

80. The system of claim 74 wherein said amplitude modulator is configured to provide said periodic modulation of the intensity of said optical signal at an intensity modulation depth greater than or equal to 80%.

81. The system of claim 74 wherein amplitude modulator is configured to provide said periodic modulation of the intensity of said optical signal at an intensity modulation depth equal to about 100%.

82. The system of claim 74 wherein said amplitude modulator is configured to impart said periodic modulation in response to a sinusoidal drive signal.

83. The system of claim 74 wherein said periodic modulation is provided at an amplitude modulation frequency phase locked to said data modulation frequency.

84. The system of claim 83 wherein said amplitude modulation frequency is equal to said data modulation frequency.

85. The system of claim 74 further comprising:
means for measuring a predetermined characteristic of a received signal received by the receiver;
means for transmitting the predetermined characteristic to the transmitter; and
means for selectively varying the periodic modulation imparted to said optical signal to optimize the value of the predetermined characteristic.

86. The system of claim 85 wherein said data source is configured to modulate said data on said optical signal using a DPSK modulation format.

87. The system of claim 85 wherein said means for selectively varying the periodic modulation comprises means for selectively adjusting a depth of said periodic modulation.

88. The system of claim 85 wherein said predetermined characteristic comprises the signal-to-noise ratio of said received signal.

89. The system of claim 85 wherein said predetermined characteristic comprises the Q-factor of said received signal.

90. The system of claim 74 further comprising a phase modulator configured to provide optical phase modulation to said optical signal.

91. The system of claim 90 wherein said phase modulator is configured to provide said optical phase modulation at a phase modulation frequency that is phase locked to said data modulation frequency.

92. The system of claim 91 wherein said phase modulation frequency is equal to said data modulation frequency.

93. The system of claim 90 said apparatus further comprising means for selectively adjusting a level of said optical phase modulation.

94. The system of claim 90 further comprising an electrical variable-delay line for selectively varying the phase of said optical phase modulation provided by said phase modulator.

95. The system of claim 90 further comprising:
means for measuring a predetermined characteristic of a received signal received by the receiver;
means for transmitting the predetermined characteristic to the transmitter; and
means for selectively varying the phase modulation imparted to said optical signal to optimize the value of the predetermined characteristic.

96. The system of claim 95 wherein said data source is configured to modulate said data on said optical signal using a DPSK modulation format.

97. The system of claim 95 wherein said predetermined characteristic comprises the signal-to-noise ratio of said received signal.

98. The system of claim 95 wherein said predetermined characteristic comprises the Q-factor of the optical signal received by the receiver.

99. The system of claim 74 further comprising a polarization modulator for modulating the state of polarization of said optical signal at said data modulation frequency.

100. The system of claim 99 wherein said polarization modulator is configured for modulating the state of polarization of said optical signal such that an average value of the state of polarization over a modulation cycle is substantially equal to zero.

101. The system of claim 99 wherein said polarization modulator modulates the state of polarization by tracing the polarization of said optical signal along at least a portion of a Poincare sphere.

102. The system of claim 99 further comprising:
means for measuring a predetermined characteristic of an optical signal received by the receiver;
means for transmitting the predetermined characteristic to the transmitter; and
means for selectively varying the polarization modulation imparted to said optical signal to optimize the value of the predetermined characteristic.

103. The system of claim 102 wherein said predetermined characteristic comprises the signal-to-noise ratio of the optical signal received by the receiver.

104. The system of claim 102 wherein said predetermined characteristic comprises the Q-factor of the optical signal received by the receiver.
